(19) United States
(12) Patent Application Publication
(10) Pub. No.: US 2026/0299511 A1
(43) Pub. Date: Oct. 1, 2026

(54) DEVELOPING DEVICE

(71) Applicant: FUJIFILM Business Innovation Corp., Tokyo (JP)

(72) Inventors: Yuta SHIMATATE, Kanagawa (JP); Shunsuke YAMASAKI, Kanagawa (JP)

(73) Assignee: FUJIFILM Business Innovation Corp., Tokyo (JP)

(21) Appl. No.: 19/260,243

(22) Filed: Jul. 3, 2025

(30) Foreign Application Priority Data
Mar. 26, 2025 (JP) 2025-052284

(51) Int. Cl. G03G 21/20; G03G 21/16

(52) U.S. Cl. CPC G03G 21/206; G03G 21/1676; G03G 2221/163; G03G 2221/1645

(57) ABSTRACT

A developing device that is composed of plural constituent members and that causes a developer to adhere to an image holding body holding an image includes a facing member that is provided to be rotatable and that is disposed at a position facing the image holding body, an opening that is disposed in a state of facing an image holding body side and that is for supply of the developer to the image holding body, a blocking member that partially blocks the opening and that is disposed in a state where a gap is provided between the blocking member and the facing member that is disposed on a side opposite to a side on which the image holding body is installed with the blocking member interposed therebetween, a flow path that extends in an axial direction of the facing member provided to be rotatable, through which air flows in the axial direction, and that reaches the gap at an end portion on a downstream side of a flow of the air in the axial direction, a suction port that is provided at the end portion of the flow path on the downstream side in the axial direction and into which the air in the flow path is sucked in a direction intersecting the axial direction and air in the gap is sucked, and a division portion that partially blocks the suction port and that divides the suction port into an upstream side and a downstream side in the axial direction.

### CROSS-REFERENCE TO RELATED APPLICATIONS

This application is based on and claims priority under 35 USC 119 from Japanese Patent Application No. 2025-052284 filed Mar. 26, 2025.

### BACKGROUND

### (i) Technical Field

The present invention relates to a developing device.

### (ii) Related Art

Disclosed in JP2016-90879A is an image forming apparatus including a developing device that develops an electrostatic latent image on a surface of an image carrier with toner, a suction duct that is used for suction of the toner scattered from the inside of the developing device, and a blowing unit that blows air to a wall surface of the suction duct, in which the toner adhering to the wall surface is removed by the air blown thereto.

Disclosed in JP2003-177604A is a toner scattering prevention device in an image forming apparatus including a developing device that visualizes a latent image on an image carrier by causing toner to adhere to the latent image, in which a gas discharge unit that discharges air from an upper portion in the developing device through a gas discharge path is provided, air is sucked from the inside of the developing device so that an air stream that causes air around an opening portion of the developing device to be sucked through the opening portion, and a suctioning port of a gas discharge path in the developing device is provided outside an image forming width.

### SUMMARY

For example, in a case where the internal pressure of a developing machine increases due to high-density installation attributable to multi-colorization, the amount of cloud inside the developing machine increases. Particularly, in a non-image region, cloud in the developing machine is more likely to flow out than in an image region, which results in a large amount of cloud. Here, for example, in a case where an opening leading to an image holding body side from the non-image region is blocked by a blocking member in order that cloud in the non-image region is restrained from flowing to the image holding body side, air in the non-image region is made stagnant. Accordingly, a developer of the cloud is likely to accumulate on a rear side of the blocking member.

Aspects of non-limiting embodiments of the present disclosure relate to a developing device that suppresses accumulation of a developer on a rear side of a blocking member.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a developing device that is composed of a plurality of constituent members and that causes a developer to adhere to an image holding body holding an image, the developing device including a facing member that is provided to be rotatable and that is disposed at a position facing the image holding body, an opening that is disposed in a state of facing an image holding body side and that is for supply of the developer to the image holding body, a blocking member that partially blocks the opening and that is disposed in a state where a gap is provided between the blocking member and the facing member that is disposed on a side opposite to a side on which the image holding body is installed with the blocking member interposed therebetween, a flow path that extends in an axial direction of the facing member provided to be rotatable, through which air flows in the axial direction, and that reaches the gap at an end portion on a downstream side of a flow of the air in the axial direction, a suction port that is provided at the end portion of the flow path on the downstream side in the axial direction and into which the air in the flow path is sucked in a direction intersecting the axial direction and air in the gap is sucked, and a division portion that partially blocks the suction port and that divides the suction port into an upstream side and a downstream side in the axial direction.

### BRIEF DESCRIPTION OF THE DRAWINGS

Exemplary embodiment(s) of the present invention will be described in detail based on the following figures, wherein:

FIG. 1 is a view illustrating an image forming apparatus;

FIG. 2 is a view of a developing device as seen from above;

FIG. 3 is a cross-sectional view of the developing device taken along line III-III in FIG. 2;

FIG. 4 is a cross-sectional view of the developing device taken along line IV-IV in FIG. 2;

FIG. 5 is a cross-sectional view of the developing device taken along line V-V in FIG. 2;

FIG. 6 is an explanatory view for description of a developer suction mechanism in the developing device;

FIG. 7 is a view showing how one end portion of the developing device is in a case where the one end portion is seen in a direction represented by an arrow VII in FIG. 2;

FIG. 8 is a perspective view showing one end portion side of the developing device as seen from the other end portion side of the developing device;

FIG. 9 is a perspective view showing the one end portion of the developing device as seen in a direction represented by an arrow IX in FIG. 7;

FIG. 10 is a view of the developing device as seen from below;

FIG. 11 is a view showing a state where a blocking member and an exterior cover of the developing device shown in FIG. 7 are removed;

FIG. 12 is a view showing the developing device as seen in a direction XII in FIG. 9 and is a view showing a state where the blocking member and the exterior cover of the developing device are removed; and

FIGS. 13A and 13B are views for comparison between the sizes of a first opening and a second opening, where FIG. 13A is a view showing the first opening and FIG. 13B is a view showing the second opening.

### DETAILED DESCRIPTION OF THE INVENTION

An exemplary embodiment of the present invention will be described below with reference to the accompanying drawings.

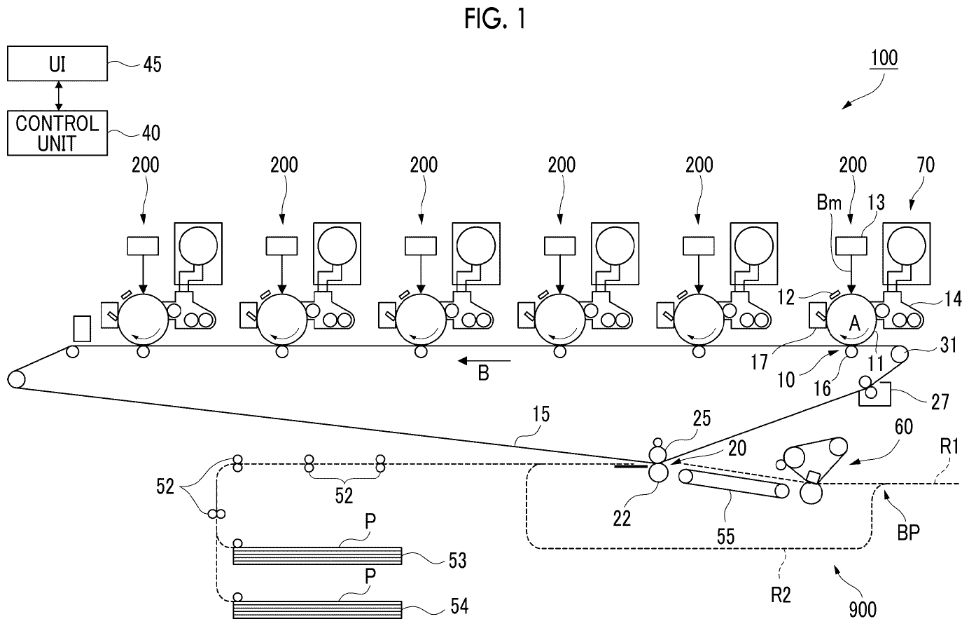

FIG. 1 is a view showing an image forming apparatus 100 according to the present exemplary embodiment. FIG. 1 shows a state related to a case where the image forming apparatus 100 is seen from a side ahead of the image forming apparatus 100.

The image forming apparatus 100 is an intermediate transfer type image forming apparatus 100, which is called a tandem type image forming apparatus.

The image forming apparatus 100 is provided with a plurality of image forming units 200 that form images to be transferred to a paper sheet P, which is an example of a recording medium.

Each of the image forming units 200 includes a photoreceptor drum 11, which is an example of an image holding body, and forms a toner image, which is an image to be transferred to the paper sheet P, on the photoreceptor drum 11 by using a developer containing toner. In other words, each of the image forming units 200 forms, on the photoreceptor drum 11 by using a powdery developer, a toner image to be transferred to the paper sheet P.

A developer of the present exemplary embodiment is composed of a dry carrier and dry toner. Each of the image forming units 200 uses a carrier and toner to form a toner image on the photoreceptor drum 11.

Six image forming units 200 form toner images on the photoreceptor drums 11 by using different types of developers.

Specifically, in the present exemplary embodiment, four of the six image forming units 200 form toner images by using developers of basic colors which are yellow, magenta, cyan, and black.

In addition, the remaining two image forming units 200 form toner images by using a developer of a color other than the basic colors, such as clear, white, gold, silver, pink, green, or orange.

Note that examples of the developer of a color other than the basic colors include a developer containing magnetic toner and a developer containing conductive toner, in addition to the above-described developer. In addition, examples of the developer of a color other than the basic colors include a developer containing toner that emits light in a case where the toner is irradiated with light such as ultraviolet rays or infrared rays.

In the present exemplary embodiment, a so-called two-component developer in which a carrier and toner are mixed with each other is used as the developer. However, the present invention is not limited thereto, and a so-called one-component developer composed of toner only may also be used as the developer.

In addition, the image forming apparatus 100 is provided with an intermediate transfer belt 15 and primary transfer units 10 provided to transfer toner images to the intermediate transfer belt 15, the toner images being respectively formed by the image forming units 200.

Furthermore, the image forming apparatus 100 is provided with a secondary transfer unit 20 provided to transfer, to the paper sheet P, the toner images transferred onto the intermediate transfer belt 15.

In addition, the image forming apparatus 100 is provided with a fixing device 60 that fixes, onto the paper sheet P, the toner images transferred onto the paper sheet P.

Furthermore, the image forming apparatus 100 is provided with a control unit 40 that includes a CPU executing a program and that controls each unit in the image forming apparatus 100.

In addition, the image forming apparatus 100 is provided with a user interface (UI) 45 that is composed of a display panel or the like, that receives an instruction from a user, and that displays information with respect to the user.

Each of the image forming units 200 is provided with a developing device 14. In addition, each of the image forming units 200 is provided with a developer replenishment device 70 that replenishes the developing device 14 with a developer.

The developing device 14 visualizes an electrostatic latent image on the photoreceptor drum 11 with toner. In other words, the developing device 14 performs development with respect to the photoreceptor drum 11, which is an image holding body, to form, on the photoreceptor drum 11, an image formed by the toner.

The developer replenishment device 70 replenishes the developing device 14 with a developer. As described above, a developer is composed of a carrier and toner, and the developer replenishment device 70 replenishes the developing device 14 with a carrier and toner as a developer. Note that in the present exemplary embodiment, a carrier has a positive charging polarity, and toner has a negative charging polarity.

In each of the image forming units 200, the photoreceptor drum 11 which is an example of an image holding body rotates in a direction along an arrow A.

In addition, each of the image forming units 200 is provided with a charger 12 that charges the photoreceptor drum 11 and a laser exposure device 13 which is an example of an exposure device forming an electrostatic latent image on the photoreceptor drum 11. In FIG. 1, an exposure beam from the laser exposure device 13 is represented by a reference numeral “Bm”. Note that the exposure device may be composed of a device including a light source, such as an LED.

In addition, each of the image forming units 200 is provided with a primary transfer roll 16 that transfers a toner image formed on the photoreceptor drum 11 to the intermediate transfer belt 15 at the primary transfer unit 10. In addition, each of the image forming units 200 is provided with a drum cleaner 17 that removes a developer remaining on the photoreceptor drum 11.

A drive roll 31 driven by a motor (not shown) causes the intermediate transfer belt 15 to circulate and move at a predetermined speed in a direction along an arrow B which is shown in FIG. 1.

The primary transfer unit 10 is configured to include the primary transfer roll 16 that is disposed to face the photoreceptor drum 11 with the intermediate transfer belt 15 interposed therebetween. In addition, respective toner images on the photoreceptor drums 11 are electrostatically attracted onto the intermediate transfer belt 15 in order, so that superimposed toner images are formed on the intermediate transfer belt 15.

The secondary transfer unit 20 which is an example of a transfer unit is configured to include a secondary transfer roll 22 that is disposed on an outer surface side of the intermediate transfer belt 15 and a backup roll 25 that is disposed on an inner surface side of the intermediate transfer belt 15.

In the present exemplary embodiment, at the secondary transfer unit 20, toner images that are formed by the image forming units 200 and that are transferred to the intermediate transfer belt 15 are transferred to the paper sheet P transported to the secondary transfer unit 20.

Furthermore, in the present exemplary embodiment, an inversion mechanism 900 that inverts the paper sheet P is provided.

The inversion mechanism 900 inverts the paper sheet P with one surface on which the toner images have been transferred at the secondary transfer unit 20 upside down and supplies the paper sheet P again to the secondary transfer unit 20.

Accordingly, in the present exemplary embodiment, toner images can be formed on both surfaces of the paper sheet P.

Specifically, in the present exemplary embodiment, the inversion mechanism 900 inverts the paper sheet P upside down by feeding the paper sheet P, which has passed through the fixing device 60, to a branch path R2 branching off a paper sheet transport path R1. Specifically, after the paper sheet P passes through a branching portion BP, the inversion mechanism 900 transports the paper sheet P in a reverse direction and feeds the paper sheet P to the branch path R2.

The branch path R2 joins the paper sheet transport path R1 at a position upstream of the secondary transfer unit 20. Accordingly, in the present exemplary embodiment, the paper sheet P inverted upside down is supplied again to the secondary transfer unit 20. In this case, toner images are formed not only on the one surface of the paper sheet P but also on the other surface of the paper sheet P, so that the toner images are formed on both surfaces of the paper sheet P.

The flow of processing performed in the image forming apparatus 100 will be described.

The image forming apparatus 100 receives image data output from, for example, an image reading apparatus (not shown) or a computer. Then, the image data is subjected to image processing. Accordingly, image data corresponding to each of the plurality of image forming units 200 is generated.

Specifically, for example, image data used for image formation in which the developers of the basic colors, which are yellow, magenta, cyan, and black, are used and image data used for image formation in which the developer of a color other than the basic colors is used are generated. The generated image data is output to the laser exposure devices 13 provided at the image forming units 200.

In accordance with the image data input to the laser exposure devices 13, the laser exposure devices 13 irradiate the photoreceptor drums 11 with the exposure beams Bm emitted from, for example, semiconductor lasers.

In the present exemplary embodiment, after respective surfaces of the photoreceptor drums 11 are charged by the chargers 12, the surfaces are scanned and exposed to light by the laser exposure devices 13. Accordingly, electrostatic latent images are formed on the surfaces of the photoreceptor drums 11.

Next, development processing is performed by the developing devices 14 so that toner images are formed on the photoreceptor drums 11. The toner images are transferred onto the intermediate transfer belt 15 at the primary transfer units 10.

After the toner images are transferred onto the intermediate transfer belt 15, the toner images are moved to the secondary transfer unit 20 as the intermediate transfer belt 15 moves. In addition, at this time, the paper sheet P from a first paper sheet accommodation portion 53 or a second paper sheet accommodation portion 54 is transported to the secondary transfer unit 20 by transport rolls 52 or the like.

Then, the toner images on the intermediate transfer belt 15 are electrostatically transferred onto the paper sheet P in a collective manner at the secondary transfer unit 20.

Thereafter, the paper sheet P onto which the toner images have been transferred is peeled from the intermediate transfer belt 15 and is transported to a transport belt 55. The transport belt 55 transports the paper sheet P to the fixing device 60.

The paper sheet P transported to the fixing device 60 is heated and pressed by the fixing device 60. Accordingly, the toner images on the paper sheet P are fixed to the paper sheet P. Then, the paper sheet P is discharged from the image forming apparatus 100.

Note that in a case where toner images are to be formed on both surfaces of the paper sheet P, the paper sheet P is supplied again to the secondary transfer unit 20 through the branch path R2 after the paper sheet P passes through the fixing device 60.

Then, toner images are transferred to the other surface of the paper sheet P at the secondary transfer unit 20. Thereafter, the paper sheet P passes through the fixing device 60 again and the toner images transferred to the other surface are fixed to the paper sheet P.

The developing devices 14 will be described.

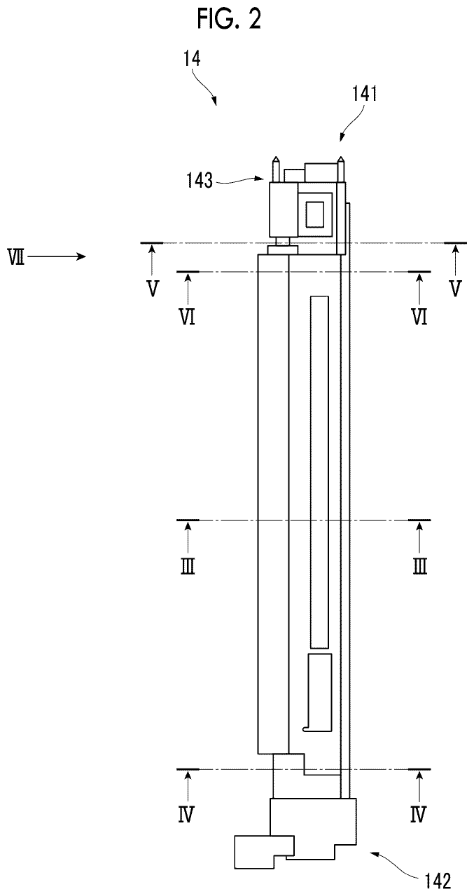

FIG. 2 is a view showing the developing device 14 as seen from above.

In a case where the developing device 14 is installed in the image forming apparatus 100, the developing device 14 is disposed along a depth direction of the image forming apparatus 100. The developing device 14 includes one end portion 141 and the other end portion 142, of which the positions are different from each other in a longitudinal direction.

In a case where the developing device 14 is installed in the image forming apparatus 100, the developing device 14 is installed in the image forming apparatus 100 such that the one end portion 141 is positioned on a rear side of the image forming apparatus 100 and the other end portion 142 is positioned on a front side of the image forming apparatus 100.

A drive force receiving portion 143 that receives a drive force is provided at the one end portion 141 of the developing device 14.

In the present exemplary embodiment, a drive force from a drive source (not shown), such as a motor, is transmitted to the drive force receiving portion 143, the drive source being provided on a body side of the image forming apparatus 100.

The drive force receiving portion 143 is linked to a transport member or the like (which will be described later) provided inside the developing device 14. In the present exemplary embodiment, the transport member or the like is rotated as the drive force from the drive source is transmitted to the drive force receiving portion 143.

In the present exemplary embodiment, as will be described later, four members, which are an one-direction transport member, an opposite-direction transport member, a facing member, and a lower-side transport member, are provided as members that rotate as the drive force is received from the drive source. The drive force receiving portion 143 may be provided to correspond to each of the four members. In addition, a drive force from the drive source may be transmitted to each of four drive force receiving portions 143.

In addition, alternatively, drive force receiving portions 143 of which the number is smaller than the number of the four members, for example, one drive force receiving portion 143, may be provided. In addition, a drive force transmitted from the drive source to the drive force receiving portion 143 may be transmitted to each of the four members through a transmission mechanism (not shown) provided at the developing device 14.

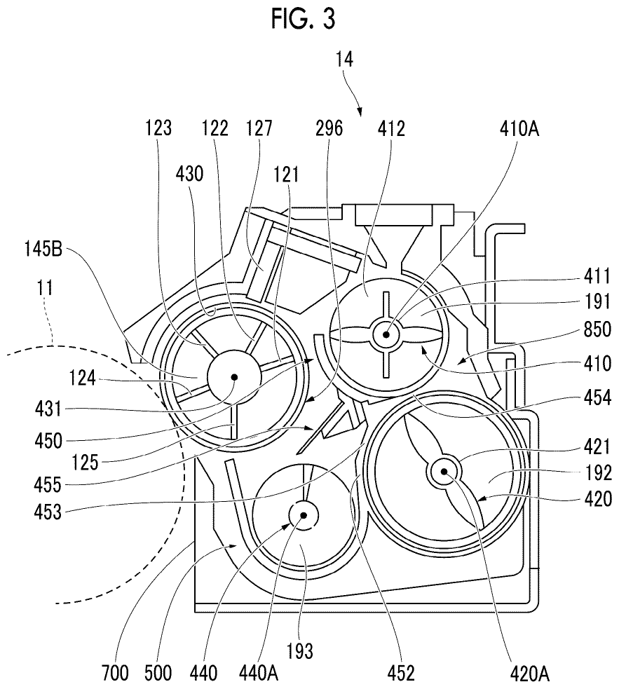

FIG. 3 is a cross-sectional view of the developing device 14 taken along line III-III in FIG. 2. FIG. 3 shows the state of a cross section of a central portion of the developing device 14 in the longitudinal direction.

The developing device 14 is provided with an one-direction movement path 191 through which a developer passes in a case where the developer is to be moved in one direction.

In addition, the developing device 14 is provided with an opposite-direction movement path 192 through which the developer passes in a case where the developer is to be moved in a direction opposite to the one direction. The opposite-direction movement path 192 is disposed below the one-direction movement path 191.

In the one-direction movement path 191, the developer moves in a direction perpendicular to the paper surface of FIG. 3 and in a direction to the rear side of the paper surface. In addition, in the opposite-direction movement path 192, the developer moves in a direction perpendicular to the paper surface of FIG. 3 and in a direction to the front side of the paper surface.

The one-direction movement path 191 is provided with an one-direction transport member 410 that transports the developer. In the present exemplary embodiment, the developer moves in the direction to the rear side as the one-direction transport member 410 rotates around a rotary shaft 411 that extends along the one-direction movement path 191.

More specifically, in the present exemplary embodiment, the developer moves in the direction to the rear side as the one-direction transport member 410 receives a drive force transmitted from the above-described drive force receiving portion 143 (refer to FIG. 2) and the one-direction transport member 410 rotates.

In the present exemplary embodiment, the one-direction transport member 410 transports the developer in the direction to the rear side, which is the one direction. The one-direction transport member 410 is a rotating member that rotates around an axis 410A extending along the one direction.

The opposite-direction movement path 192 is provided with an opposite-direction transport member 420 that transports the developer. The opposite-direction transport member 420 is disposed below the one-direction transport member 410.

In the present exemplary embodiment, the developer moves in the direction to the front side as the opposite-direction transport member 420 rotates around a rotary shaft 421 that extends along the opposite-direction movement path 192.

More specifically, the developer moves in the direction to the front side as the opposite-direction transport member 420 receives a drive force transmitted from the above-described drive force receiving portion 143 and the opposite-direction transport member 420 rotates.

In the present exemplary embodiment, the opposite-direction transport member 420 transports the developer in the direction opposite to the one direction.

A facing member 430 that is disposed at a position facing the photoreceptor drum 11, which is an example of an image holding body, is provided to the left of the one-direction transport member 410.

The facing member 430 supplies, to the photoreceptor drum 11, a developer supplied from the one-direction transport member 410. The developer is supplied from the one-direction transport member 410 to the facing member 430 and the facing member 430 supplies the developer to the photoreceptor drum 11.

The facing member 430 is composed of a cylindrical body. The facing member 430 is formed of, for example, a metal such as SUS.

The facing member 430 receives a drive force transmitted from the drive force receiving portion 143, rotates in a counterclockwise direction in the drawing around an axis 431, and moves, to the photoreceptor drum 11, a developer that is supplied from the one-direction transport member 410 and that adheres to an outer peripheral surface of the facing member 430.

Accordingly, the developer is supplied to the photoreceptor drum 11, and toner contained in the developer adheres to a surface of the photoreceptor drum 11.

The facing member 430 is a rotating member that rotates around the axis 431 extending along the above-described one direction. In addition, the one-direction transport member 410 is also a rotating member that rotates around the axis 410A extending along the above-described one direction.

In the present exemplary embodiment, the facing member 430 and the one-direction transport member 410 are provided such that the axis 410A of the one-direction transport member 410 is positioned above the axis 431 of the facing member 430.

Furthermore, in the present exemplary embodiment, a first movement restriction portion 450 that is disposed between the facing member 430 and the one-direction transport member 410 and that restricts movement of a portion of a developer caused to move toward the facing member 430 from the one-direction transport member 410 is provided.

In the present exemplary embodiment, a part of a developer on the one-direction movement path 191 that moves over the first movement restriction portion 450 is supplied to the facing member 430.

Furthermore, in the present exemplary embodiment, a lower-side transport member 440 that is disposed below the facing member 430 is provided. The lower-side transport member 440 is a rotating member that rotates around an axis 440A extending along the above-described one direction.

The lower-side transport member 440 is disposed closer to the photoreceptor drum 11 side than the opposite-direction transport member 420 is.

The lower-side transport member 440 and the opposite-direction transport member 420 are disposed along the above-described one direction and are disposed in a state where the positions thereof are offset from each other in a horizontal direction.

The lower-side transport member 440 transports a developer separated from the facing member 430 in the direction perpendicular to the paper surface of FIG. 3 and in the direction to the rear side of the paper surface.

The lower-side transport member 440 transports the developer separated from the facing member 430 in the above-described one direction, so that the developer is supplied to one end portion side of the opposite-direction transport member 420 (details will be described later).

The lower-side transport member 440 is rotated by a drive force transmitted from the drive force receiving portion 143, so that the lower-side transport member 440 transports a developer separated from the facing member 430 in the direction perpendicular to the paper surface of FIG. 3 and in the direction to the rear side of the paper surface.

The lower-side transport member 440 is provided on a lower-side movement path 193 that is disposed closer to the photoreceptor drum 11 side than the opposite-direction movement path 192 is.

The lower-side movement path 193 is disposed to extend in the direction perpendicular to the paper surface of FIG. 3 and is disposed below the facing member 430. In the present exemplary embodiment, the developer separated from the facing member 430 moves along the lower-side movement path 193.

Furthermore, in the present exemplary embodiment, a second movement restriction portion 452 that is disposed between the lower-side transport member 440 and the opposite-direction transport member 420 and that restricts movement of a developer moving toward the lower-side transport member 440 from the opposite-direction transport member 420 is provided.

In addition, in the present exemplary embodiment, a third movement restriction portion 453 that is disposed between the facing member 430 and the opposite-direction transport member 420 and that restricts movement of a developer moving toward the facing member 430 from the opposite-direction transport member 420 is provided.

Furthermore, in the present exemplary embodiment, a fourth movement restriction portion 454 is provided between the one-direction transport member 410 and the opposite-direction transport member 420.

The fourth movement restriction portion 454 restricts movement of a developer moving from the one-direction transport member 410 to the opposite-direction transport member 420. In addition, the fourth movement restriction portion 454 restricts movement of a developer moving from the opposite-direction transport member 420 to the one-direction transport member 410.

In the present exemplary embodiment, the second to fourth movement restriction portions 452 to 454 are integrated with each other. The second to fourth movement restriction portions 452 to 454 are configured by means of one common component.

Furthermore, in the present exemplary embodiment, a fifth movement restriction portion 455 that is disposed between the facing member 430 and the lower-side transport member 440 and that restricts movement of a developer moving toward the facing member 430 from the lower-side transport member 440 is provided.

Furthermore, in the present exemplary embodiment, a magnet roll 145B is provided inside the facing member 430.

The magnet roll 145B is provided with five magnetic poles 121 to 125 arranged in a circumferential direction of the magnet roll 145B.

The magnetic pole 121 is a pickup pole and attracts a developer supplied from the one-direction movement path 191. Accordingly, the developer adheres to a surface of the facing member 430.

The magnetic poles 122 to 124 have a role as transport poles and move the developer on the surface of the facing member 430 to a downstream side in a rotation direction of the facing member 430.

In the rotation direction of the facing member 430, a facing restriction portion 127 is provided downstream of the magnetic pole 122 and upstream of the magnetic pole 123. In addition, the facing restriction portion 127 is disposed at a position facing the outer peripheral surface of the facing member 430.

The facing restriction portion 127 is disposed with a gap provided between the facing restriction portion 127 and the facing member 430.

The facing restriction portion 127 restricts movement of a portion of a developer adhering to the surface of the facing member 430, so that the thickness of the developer adhering to the surface of the facing member 430 becomes a predetermined thickness.

In other words, the facing restriction portion 127 restricts movement of a portion of a developer that adheres to the outer peripheral surface of the facing member 430 and that moves toward the photoreceptor drum 11 as the facing member 430 rotates.

In a case where the developer on the surface of the facing member 430 moves to the downstream side in the rotation direction of the facing member 430, the developer moves to the surface of the photoreceptor drum 11 which is an example of an image holding body and toner contained in the developer adheres to the photoreceptor drum 11.

Accordingly, development is performed, and an image consisting of the toner is formed on the surface of the photoreceptor drum 11.

The image is temporarily held by the photoreceptor drum 11 and is moved to the primary transfer unit 10 (refer to FIG. 1) with the photoreceptor drum 11 rotating. Then, the image is transferred to the intermediate transfer belt 15.

The magnetic pole 125 has a role as a pick-off pole, forms a repulsive magnetic field, and causes the developer adhering to the surface of the facing member 430 to be separated from the facing member 430. The magnetic pole 125 causes the developer that remains on the surface of the facing member 430 without being transferred to the photoreceptor drum 11 to be separated from the facing member 430.

In the present exemplary embodiment, separation of the developer occurs at a separation position 296.

In the present exemplary embodiment, the separation position 296 is positioned ahead of the magnetic pole 121 having a role as a pickup pole, and the developer is separated ahead of the magnetic pole 121 in the present exemplary embodiment.

The developer separated from the facing member 430 moves downward and reaches the lower-side movement path 193.

The developer that has reached the lower-side movement path 193 is moved toward the one end portion 141 (refer to FIG. 2) side of the developing device 14 by the lower-side transport member 440, and then is moved to the opposite-direction movement path 192 (refer to FIG. 3) (details will be described later).

The one-direction transport member 410 (see FIG. 3), the opposite-direction transport member 420, the facing member 430, the magnet roll 145B, and the lower-side transport member 440 are disposed to extend in the direction perpendicular to the paper surface of FIG. 3 and to be parallel to each other.

The one-direction transport member 410 includes the rotary shaft 411 that extends along the longitudinal direction of the developing device 14 and a protruding portion 412 that protrudes from an outer peripheral surface of the rotary shaft 411.

The protruding portion 412 is provided over an area extending from one end portion to the other end portion of the rotary shaft 411 in an axial direction and is provided in a spiral shape. In other words, the protruding portion 412 is provided in a screw-like shape.

In the present exemplary embodiment, in a case where the rotary shaft 411 provided at the one-direction transport member 410 rotates, the protruding portion 412 presses a developer in the axial direction of the rotary shaft 411 and thus the developer moves in a direction in which the rotary shaft 411 extends.

Note that the opposite-direction transport member 420 and the lower-side transport member 440 have the same configuration as the one-direction transport member 410, and the opposite-direction transport member 420 and the lower-side transport member 440 are also provided with a rotary shaft extending along the longitudinal direction of the developing device 14 and a protruding portion having a spiral shape.

The one-direction transport member 410, the opposite-direction transport member 420, the facing member 430, and the lower-side transport member 440 are rotating members that rotate around axes extending along the above-described one direction.

In the present exemplary embodiment, an axis 420A of the opposite-direction transport member 420 is positioned to be farther from the facing member 430 than the axis 410A of the one-direction transport member 410 is in a case where the positions of the axes in the horizontal direction are compared with each other.

In addition, in the present exemplary embodiment, the axis 420A of the opposite-direction transport member 420 is positioned at a position offset from a position directly below the axis 410A of the one-direction transport member 410.

In addition, in the present exemplary embodiment, the axis 440A of the lower-side transport member 440 is positioned at a position offset from a position directly below the axis 431 of the facing member 430.

More specifically, in the present exemplary embodiment, the axis 440A of the lower-side transport member 440 is positioned to be closer to the opposite-direction transport member 420 than the axis 431 of the facing member 430 is in a case where the positions of the axes in the horizontal direction are compared with each other.

Furthermore, in the present exemplary embodiment, the axis 440A of the lower-side transport member 440 is positioned below the axis 420A of the opposite-direction transport member 420 in a case where the positions of the axes in a perpendicular direction are compared with each other.

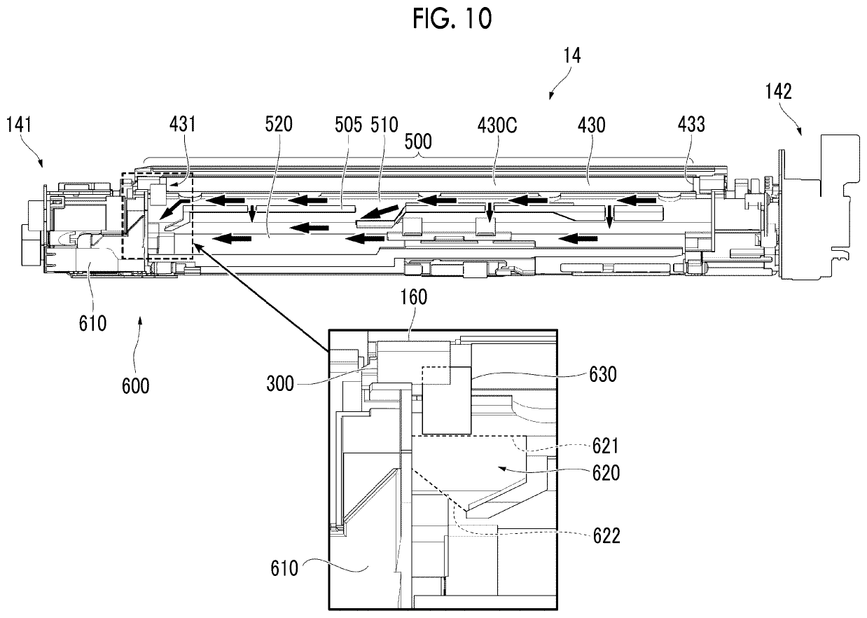

The developing device 14 includes an exterior cover 700 that is a housing protecting the developing device 14. The exterior cover 700 covers a lower portion of the developing device 14. An inner surface of the exterior cover 700, that is, a surface facing the lower-side movement path 193 side is an arc-shaped surface extending along an outer surface of the lower-side movement path 193 having a cylindrical shape. A gap is provided between the inner surface of the exterior cover 700 and the outer surface of the lower-side movement path 193. The exterior cover 700 is disposed to extend in the direction perpendicular to the paper surface of FIG. 3. In the present exemplary embodiment, a flow path 500 (refer to FIG. 10 to be described later) through which air flows is formed by the gap provided between the inner surface of the exterior cover 700 and the outer surface of the lower-side movement path 193.

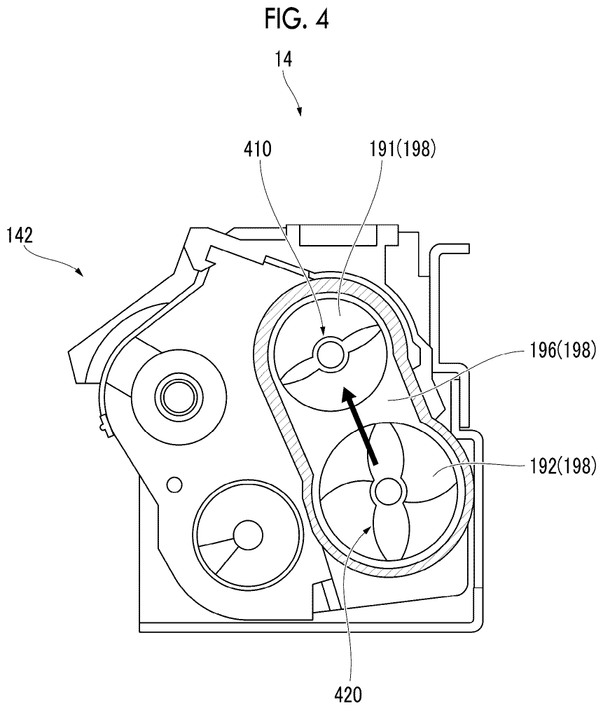

FIG. 4 is a cross-sectional view of the developing device 14 taken along line IV-IV in FIG. 2.

FIG. 4 shows the state of a cross section of the other end portion 142 of the developing device 14.

In the present exemplary embodiment, as shown in FIG. 4, an upward movement path 196 disposed along the vertical direction is provided at the other end portion 142 of the developing device 14.

In the present exemplary embodiment, a developer that has moved through the opposite-direction movement path 192 moves toward the one-direction movement path 191 through the upward movement path 196.

In the developing device 14 of the present exemplary embodiment, the upward movement path 196 which is an example of a second movement path, through which a developer moving from the opposite-direction transport member 420 to the one-direction transport member 410 passes, is provided.

Here, the expression “being disposed along the vertical direction” means not only a state where the upward movement path 196 is disposed along the perpendicular direction but also a state where the upward movement path 196 is disposed in a state of being inclined with respect to the perpendicular direction.

In the present exemplary embodiment, in a case where a developer is transported to the other end portion 142 of the developing device 14 by the opposite-direction transport member 420, the developer accumulates at a lower portion of the upward movement path 196 and the developer gradually moves upward in the upward movement path 196.

Accordingly, the developer is supplied to the one-direction transport member 410. The one-direction transport member 410 transports, toward the one end portion 141 (refer to FIG. 2) of the developing device 14 along the one-direction movement path 191, a developer that has moved through the upward movement path 196.

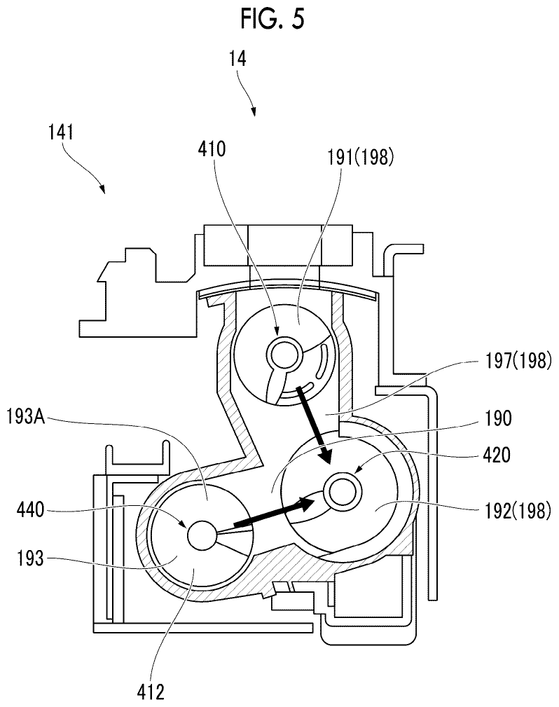

FIG. 5 is a cross-sectional view of the developing device 14 taken along line V-V in FIG. 2.

In the present exemplary embodiment, as shown in FIG. 5, a downward movement path 197 disposed along the vertical direction is provided at the one end portion 141 of the developing device 14.

Here, the expression “being disposed along the vertical direction” means not only a state where the downward movement path 197 is disposed along the perpendicular direction but also a state where the downward movement path 197 is disposed in a state of being inclined with respect to the perpendicular direction.

In the present exemplary embodiment, a developer that has moved through the one-direction movement path 191 moves toward the opposite-direction movement path 192 through the downward movement path 197.

In the present exemplary embodiment, the downward movement path 197 which is an example of a first movement path, through which a developer moving from the one-direction transport member 410 to the opposite-direction transport member 420 passes, is provided.

In the present exemplary embodiment, a developer that has moved through the one-direction movement path 191 moves toward the opposite-direction movement path 192 through the downward movement path 197. Next, the developer moves toward the other end portion 142 (refer to FIG. 2) of the developing device 14 through the opposite-direction movement path 192.

In the developing device 14 of the present exemplary embodiment, a developer movement path 198 that is formed in an annular shape by four paths, which are the one-direction movement path 191, the downward movement path 197, the opposite-direction movement path 192, and the upward movement path 196 (refer to FIG. 4), is provided.

In the present exemplary embodiment, a developer circulates and moves along the annular developer movement path 198.

Furthermore, in the present exemplary embodiment, as shown in FIG. 5, a connection path 190 that extends in a lateral direction and that connects the lower-side movement path 193 and the opposite-direction movement path 192 to each other is provided.

In the present exemplary embodiment, the connection path 190 which is an example of a movement path for a developer moving from the lower-side transport member 440 to the opposite-direction transport member 420 is provided.

The connection path 190 is disposed in a state of being inclined to extend obliquely upward. In other words, the connection path 190 is disposed in a state of being inclined with respect to both the horizontal direction and the perpendicular direction.

In the present exemplary embodiment, a developer that has been moved along the lower-side movement path 193 by the lower-side transport member 440 moves to the opposite-direction movement path 192 through the connection path 190.

In the present exemplary embodiment, a developer accumulating at an end portion of the lower-side movement path 193 that is positioned on a downstream side in a developer movement direction moves to the opposite-direction movement path 192 through the connection path 190 by being pressed by a developer sequentially transported from an upstream side.

In the developing device 14 of the present exemplary embodiment, as described above, the annular developer movement path 198 is provided, and a developer is agitated as the developer moves through the annular developer movement path 198.

Furthermore, in the present exemplary embodiment, while a developer to be agitated is passing through the one-direction movement path 191 (refer to FIG. 3), the developer is partially supplied to the facing member 430 over the first movement restriction portion 450 and the developer adheres to the surface of the facing member 430.

As the facing member 430 rotates, the developer adhering to the surface of the facing member 430 is moved to a position facing the photoreceptor drum 11 and thus the developer is supplied to the photoreceptor drum 11.

In a case where a portion of the developer that adheres to the surface of the facing member 430 and that is not supplied to the photoreceptor drum 11 passes through a position facing the magnetic pole 125 (refer to FIG. 3) having a role as a pick-off pole and in a case where the developer reaches the separation position 296, the developer is separated from the facing member 430 and moves downward.

The developer moving downward reaches the lower-side movement path 193 provided with the lower-side transport member 440.

The developer that has reached the lower-side movement path 193 moves through the lower-side movement path 193 to reach an end portion 193A of the lower-side movement path 193 that is positioned on the downstream side in the developer movement direction.

Thereafter, the developer moves to the opposite-direction movement path 192 through the connection path 190 by being pressed by a developer sequentially transported from the upstream side.

In a case where the developer moves to the opposite-direction movement path 192, the developer moves along the annular developer movement path 198 again.

The developing device 14 will be further described.

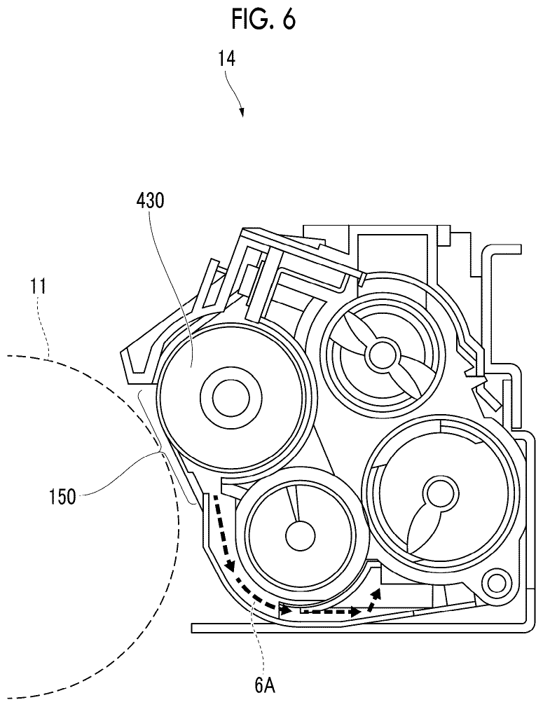

FIG. 6 is an explanatory view for description of a developer suction mechanism in the developing device 14. FIG. 6 shows a cross section of the developing device 14 taken along line VI-VI of FIG. 2.

In the present exemplary embodiment, as shown in FIG. 6, the developing device 14 is provided with an opening portion 150 facing the photoreceptor drum 11.

In the present exemplary embodiment, the facing member 430 is partially exposed through the opening portion 150.

In the present exemplary embodiment, the opening portion 150 is positioned between the photoreceptor drum 11 and a central portion of the facing member 430 in a radial direction.

The facing member 430 supplies a developer to the photoreceptor drum 11. The facing member 430 can also be regarded as a supply member.

The opening portion 150 is provided to extend in the longitudinal direction of the developing device 14. The opening portion 150 is provided to extend along an axial direction of the facing member 430.

In the image forming apparatus 100 (refer to FIG. 1) of the present exemplary embodiment, a suction device that sucks air is provided on a body side of the image forming apparatus 100.

In the present exemplary embodiment, suction performed by the suction device causes air to flow in the developing device 14 as represented by arrows 6A in FIG. 6. Accordingly, a developer floating around the developing device 14 is moved to the suction device.

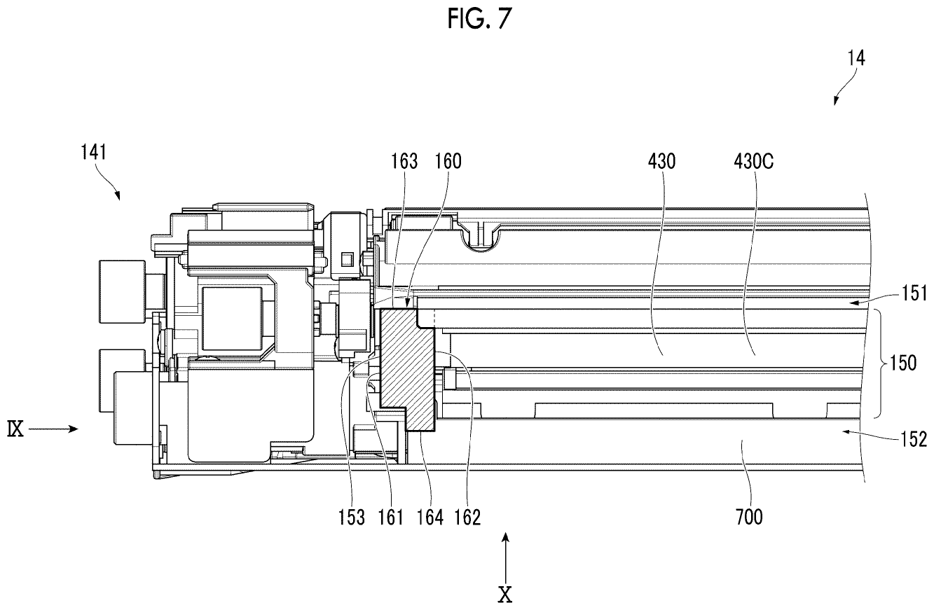

FIG. 7 is a view showing how the one end portion 141 of the developing device 14 is in a case where the one end portion 141 is seen in a direction represented by an arrow VII in FIG. 2. FIG. 7 shows the developing device 14 as seen from the opening portion 150 side.

The opening portion 150 of the developing device 14 is provided with an opening upper portion 151 that forms an upper edge of the opening portion 150 and an opening lower portion 152 that forms a lower edge of the opening portion 150. Note that in the present exemplary embodiment, a peripheral portion of the exterior cover 700 is the opening lower portion 152.

In addition, the opening portion 150 is provided with an opening left portion 153 that forms a left edge of the opening portion 150 and an opening right portion that forms a right edge of the opening portion 150. The opening right portion is not shown.

A portion of the outer peripheral surface of the facing member 430, which is exposed through the opening portion 150, is positioned between the opening upper portion 151 and the opening lower portion 152.

Furthermore, in the present exemplary embodiment, a blocking member 160 that partially blocks the opening portion 150 is provided. The blocking member 160 restricts movement of a developer.

In the present exemplary embodiment, a developer moves toward the photoreceptor drum 11 side shown in FIG. 1 from the facing member 430 side.

The blocking member 160 restricts movement of the developer moving toward the photoreceptor drum 11 side from the facing member 430 side. The blocking member 160 can also be regarded as a restriction member that restricts movement of a developer.

In the case of the developing device 14, air is taken into the developing device 14 in a case where a developer adhering to the outer peripheral surface of the facing member 430 returns to the developing device 14. Accordingly, the internal pressure of the developing device 14 increases.

Due to the increase in internal pressure, the developer in the developing device 14 is caused to move to the outside of the developing device 14 through the opening portion 150. In this case, the developer moves toward the photoreceptor drum 11 side from the facing member 430 side.

The blocking member 160 restricts movement of the developer moving toward the photoreceptor drum 11 side from the facing member 430 side.

The blocking member 160 is provided in a plate-like shape. The plate-shaped blocking member 160 is provided along the axial direction of the facing member 430. In addition, the plate-shaped blocking member 160 is provided along a circumferential direction of the facing member 430.

The blocking member 160 is formed of, for example, a resin material. Examples of the resin material include polyethylene terephthalate and polyurethane.

The blocking member 160 includes a left end portion 161 which is an example of one axial end portion and a right end portion 162 which is the other axial end portion, the right and left end portions 161 and 162 being at different positions in the axial direction of the facing member 430.

The right end portion 162 is positioned closer to a central portion 430C side of the facing member 430 in the axial direction than the left end portion 161 is.

The right end portion 162 can be understood as an end portion on a central side, which is an end portion positioned on the central portion 430C side of the facing member 430 in the axial direction.

The left end portion 161 is positioned on a side opposite to the right end portion 162 which is the central-portion-side end portion.

The left end portion 161 can be regarded as an opposite-side end portion positioned on a side opposite to the right end portion 162.

In addition, the blocking member 160 includes an upper end portion 163 that is positioned on an upstream side in the rotation direction of the facing member 430. In addition, the blocking member 160 includes a lower end portion 164 that is positioned on the downstream side in the rotation direction of the facing member 430.

The blocking member 160 is disposed at a position facing an end portion of the facing member 430 in the axial direction.

The upper end portion 163 of the blocking member 160 is affixed to, for example, a bearing member provided at an end portion of the facing member 430. The bearing member is a member that supports the facing member 430 in a rotatable state.

The upper end portion 163 of the blocking member 160 may be affixed to a member other than the bearing member, such as a housing.

In addition, the lower end portion 164 of the blocking member 160 is affixed to the exterior cover 700.

The lower end portion 164 is affixed to a surface of the exterior cover 700, that is, a surface on the photoreceptor drum 11 side. Note that the lower end portion 164 may be affixed to a rear surface of the exterior cover 700, that is, a surface on the facing member 430 side.

The blocking member 160 is provided to cover a left side of the opening portion 150 in the drawing.

Although the description will not be provided, the blocking member 160 is also provided on a right side of the opening portion 150. The blocking member 160 is also provided at a position facing the other end portion 433 of the facing member 430.

Note that the other end portion 433 of the facing member 430 is shown in FIG. 10.

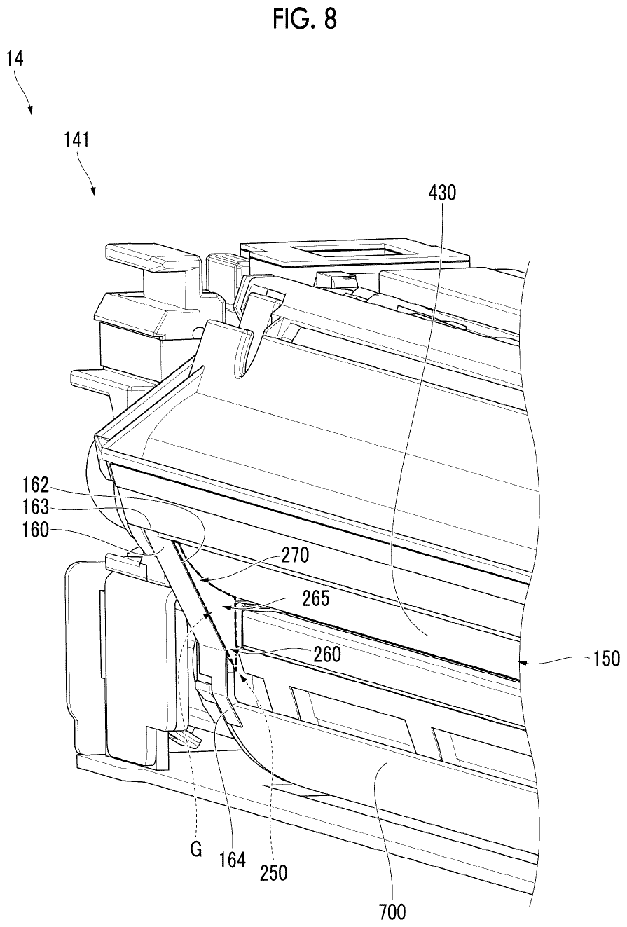

FIG. 8 is a perspective view showing the one end portion 141 side of the developing device 14 as seen from the other end portion 142 side of the developing device 14.

The blocking member 160 is disposed between the photoreceptor drum 11 shown in FIG. 6 and the facing member 430 disposed at a position facing the photoreceptor drum 11.

In the present exemplary embodiment, as described above, the upper end portion 163 of the blocking member 160 is affixed to the bearing member provided at the end portion of the facing member 430. In addition, the lower end portion 164 is affixed to the exterior cover 700.

In the present exemplary embodiment, the blocking member 160 is disposed in a state where a gap G is provided between the blocking member 160 and a plurality of constituent members constituting the developing device 14.

The blocking member 160 is disposed in a state where the gap G is provided between the blocking member 160 and the facing member 430 which is an example of a constituent member.

In the present exemplary embodiment, the blocking member 160 and the facing member 430 are not in contact with each other. The gap G is provided between the blocking member 160 and the facing member 430.

A first opening 250 through which air outside the gap G can flow into the gap G is provided between the right end portion 162 of the blocking member 160 and the facing member 430.

The first opening 250 is provided to extend in the vertical direction. The first opening 250 has different widths in the vertical direction.

Specifically, the width of a portion 260 positioned below a central portion 265 of the first opening 250 in the vertical direction and the width of a portion 270 positioned above the central portion 265 are smaller than the width of the central portion 265 of the first opening 250.

The first opening 250 is formed such that the width of the first opening 250 increases from the portion 260 positioned below the central portion 265 toward the central portion 265. In addition, the first opening 250 is formed such that the width of the first opening 250 increases from the portion 270 positioned above the central portion 265 toward the central portion 265.

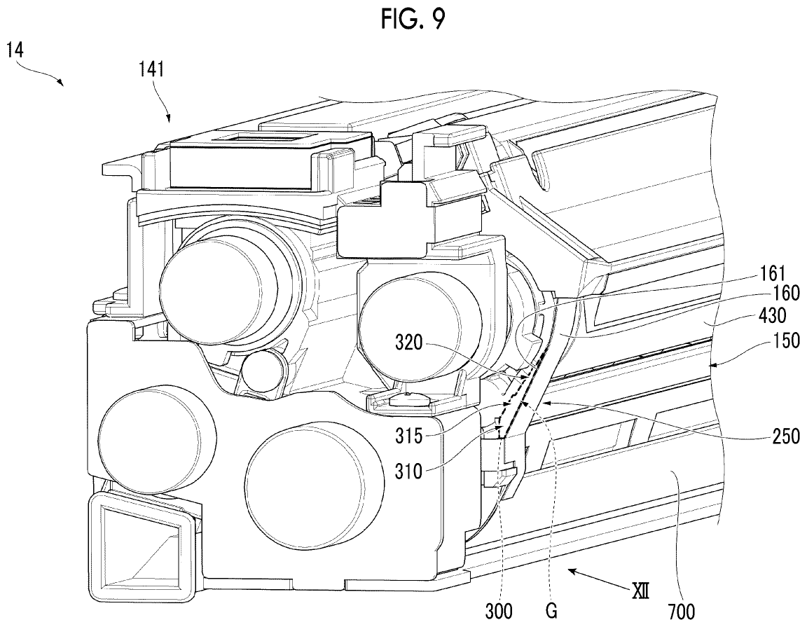

FIG. 9 is a perspective view showing the one end portion 141 of the developing device 14 as seen in a direction represented by an arrow IX in FIG. 7.

In the present exemplary embodiment, a second opening 300 is provided between the left end portion 161 of the blocking member 160 and the facing member 430. In the present exemplary embodiment, air outside the gap G flows into the gap G through the second opening 300.

In the present exemplary embodiment, as shown in FIG. 9, the second opening 300 is provided to extend in the vertical direction.

In addition, the second opening 300 is formed to have different widths in the vertical direction.

Specifically, the width of a portion 310 positioned below a central portion 315 of the second opening 300 in the vertical direction and the width of a portion 320 positioned above the central portion 315 are different from each other.

The width of the portion 310 of the second opening 300 that is positioned on a lower side in the vertical direction is larger than the width of the portion 320 that is positioned on an upper side.

Regarding the second opening 300, the width of the second opening 300 increases from the portion 320 positioned on the upper side toward the portion 310 positioned on the lower side.

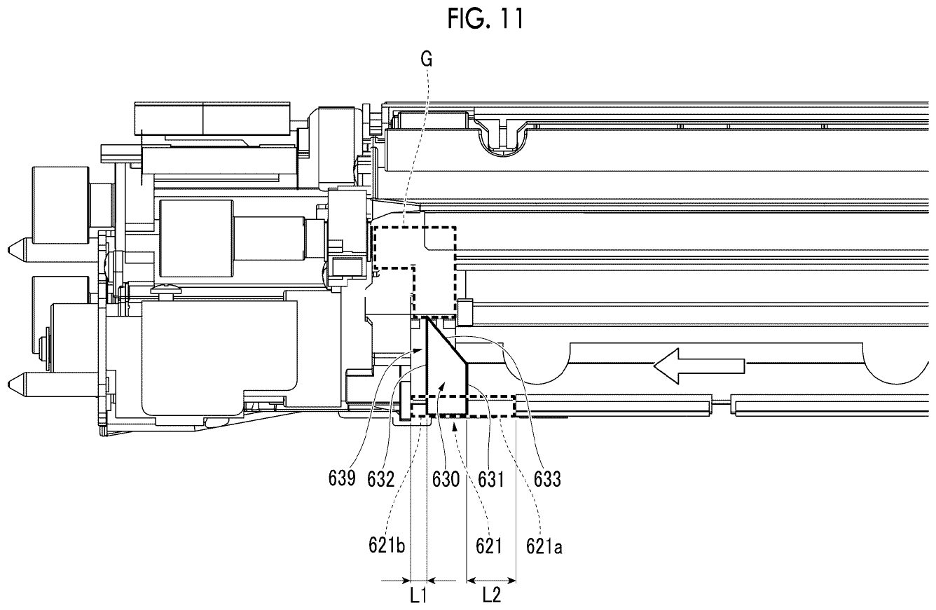

Next, the flow path 500 and a discharge portion 600 in the developing device 14 will be described with reference to FIGS. 10 and 11.

FIG. 10 is a view of the developing device 14 as seen from below. FIG. 10 shows how the developing device 14 is in a case where the developing device 14 is seen in a direction represented by an arrow X in FIG. 7. Note that in FIG. 10, a state where the exterior cover 700 of the developing device 14 is removed is shown in order to show how air flows in the developing device 14.

FIG. 11 is a view showing a state where the blocking member 160 and the exterior cover 700 of the developing device 14 shown in FIG. 7 are removed.

As shown in FIG. 10, in the present exemplary embodiment, the flow path 500 of the developing device 14 extends in the axial direction of the facing member 430. As shown in FIG. 11, the flow path 500 reaches the gap G at a downstream end portion in the axial direction, the gap G being a space on a rear side of the blocking member 160.

A developer floating at a position facing the central portion 430C or the like of the facing member 430 flows toward the one end portion 141 side of the developing device 14 through the flow path 500.

Hereinafter, in the flow path 500, the axial direction of the facing member 430 may be referred to as a main stream direction. In addition, regarding the main stream direction, the one end portion 141 side of the developing device 14 may be referred to as a downstream side, and the other end portion 142 side may be referred to as an upstream side.

As shown in FIG. 10, the flow path 500 includes a flow path wall 505 that intermittently extends along the axial direction of the facing member 430.

The flow path wall 505 separates a first flow path 510 and a second flow path 520 from each other. Air flows from the downstream side to the upstream side in the main stream direction in both the first flow path 510 and the second flow path 520. At a position where the flow path wall 505 is interrupted, a part of air in the first flow path 510 flows into the second flow path 520.

In the present exemplary embodiment, as shown in FIG. 10, the discharge portion 600 through which air in the developing device 14 is discharged is provided on the one end portion 141 side of the developing device 14.

The discharge portion 600 includes a gas discharge path 610, a suction path 620, and a division portion 630.

The gas discharge path 610 is provided on the one end portion 141 side of the developing device 14. The gas discharge path 610 is a so-called duct and is composed of an annular member.

One end-side opening of the gas discharge path 610 is connected to a suction device (not shown) and the other end-side opening of the gas discharge path 610, which is on a side opposite to the one end-side opening, is connected to the second flow path 520. In the present exemplary embodiment, the other end-side opening of the gas discharge path 610 is disposed at a surface of the second flow path 520 that is closest to the downstream side in the main stream direction.

The suction path 620 is disposed such that the air in the first flow path 510 flows to the gas discharge path 610.

Regarding the suction path 620, a suction port 621, which is one end-side opening of the suction path 620, is disposed to face the first flow path 510.

The suction port 621 of the suction path 620 faces a direction intersecting the main stream direction of the first flow path 510. In the present exemplary embodiment, the suction port 621 of the suction path 620 is disposed to face a direction perpendicular to the main stream direction of the first flow path 510.

In the present exemplary embodiment, the suction path 620 is provided to extend in the rotation direction of the facing member 430. In addition, the suction path 620 is provided to extend in the axial direction of the facing member 430. The suction path 620 is provided to be inclined with respect to both the rotation direction and the axial direction of the facing member 430.

An ejection port 622 of the suction path 620, which is an opening on a side opposite to the suction port 621, is disposed near the gas discharge path 610.

In FIG. 10, the division portion 630 is shown with a rectangular shape. In FIG. 10, a portion of the division portion 630 that is hidden by the blocking member 160 is represented by dotted lines.

The division portion 630 shown with the rectangular shape in FIG. 10 is an arc-shaped surface that extends along the arc-shaped inner surface of the exterior cover 700 (refer to FIG. 3) to become closer to a rear side of the paper surface from the suction port 621 toward the facing member 430 side.

The division portion 630 may be formed integrally with a member constituting the outer surface of the lower-side movement path 193 (refer to FIG. 3). In addition, the division portion 630 may be formed separately from the member constituting the outer surface of the lower-side movement path 193 and may be attached to the member constituting the outer surface of the lower-side movement path 193. Note that in the present exemplary embodiment, the division portion 630 is provided at the member constituting the outer surface of the lower-side movement path 193. However, the division portion 630 may be provided at the exterior cover 700.

Although the material of the division portion 630 is not particularly limited, the division portion 630 is formed of, for example, a resin material. Examples of the resin material include polyethylene terephthalate and polyurethane.

As shown in FIG. 11, the division portion 630 partially blocks the suction port 621. The division portion 630 divides the suction port 621 into an upstream side and a downstream side in the axial direction of the facing member 430. Hereinafter, the upstream side of the suction port 621 divided by the division portion 630 may be referred to as an upstream-side suction port 621a, and the downstream side of the suction port 621 may be referred to as a downstream-side suction port 621b. In FIG. 11, the length of the upstream-side suction port 621a in the axial direction of the facing member 430 is shown as a width L2 and the length of the downstream-side suction port 621b in the axial direction of the facing member 430 is shown as a width L1. In the present exemplary embodiment, L2>L1, and the upstream-side suction port 621a is wider than the downstream-side suction port 621b.

As shown in FIG. 11, the division portion 630 includes an upstream-side surface 631, a downstream-side surface 632, and an upper surface 633.

The upstream-side surface 631 is a surface extending in a direction perpendicular to the main stream direction of the first flow path 510, and is a surface facing the upstream side in the main stream direction.

The downstream-side surface 632 is a surface extending in the direction perpendicular to the main stream direction of the first flow path 510, and is a surface facing the downstream side in the main stream direction.

The downstream-side surface 632 is disposed to face, without contact, a surface of the first flow path 510 that is provided on the downstream side in the main stream direction. The downstream-side surface 632 of the first flow path 510 extends from the suction port 621 toward the gap G.

A flow path through which air flows is formed between the downstream-side surface 632 and the surface of the first flow path 510 that is on the downstream side in the main stream direction. Hereinafter, the flow path formed between the downstream-side surface 632 and the surface of the first flow path 510 that is on the downstream side in the main stream direction will be referred to as a constriction portion 639.

The upper surface 633 is a surface that extends in the gravity direction from the one end portion 141 side toward the other end portion 142 side in the axial direction of the facing member 430 in a case where the developing device 14 is disposed in the image forming apparatus 100.

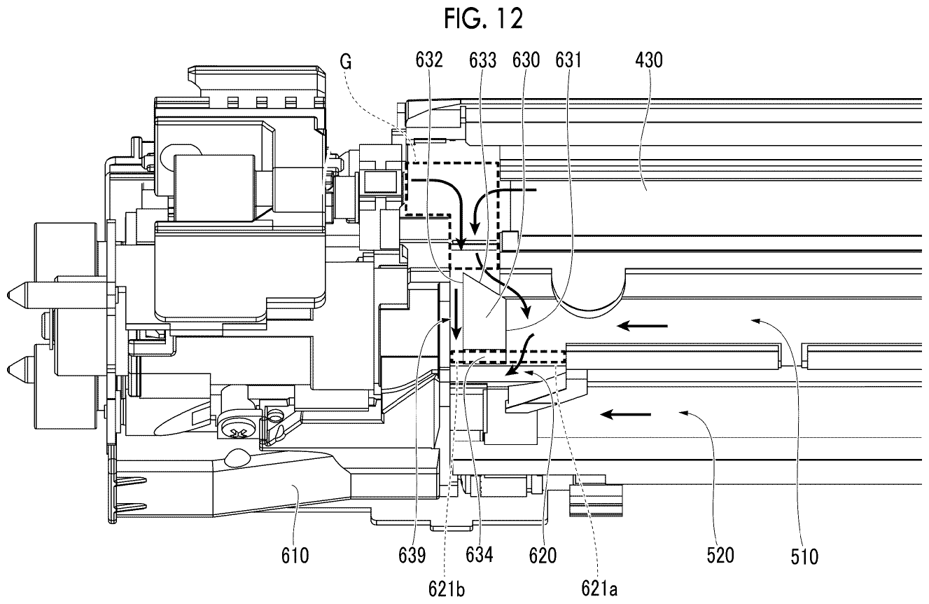

How air flows to the suction path 620 will be described with reference to FIG. 12.

FIG. 12 is a view showing the developing device as seen in a direction XII in FIG. 9 and is a view showing a state where the blocking member and the exterior cover of the developing device are removed.

As shown in FIG. 12, air flowing from the upstream side to the downstream side in the main stream direction of the first flow path 510 flows toward the upstream-side suction port 621a. Air that has flowed to the position of the upstream-side suction port 621a collides with the upstream-side surface 631 of the division portion 630 and is sucked through the upstream-side suction port 621a.

In addition, in the gap G, air flows from the constriction portion 639 to the downstream-side suction port 621b and air flows to the upstream-side suction port 621a along the upper surface 633 of the division portion 630.

In the present exemplary embodiment, air flows into the gap G through the second opening 300 (refer to FIG. 9). The air flowing in through the second opening 300 generally flows to the constriction portion 639.

In addition, in the present exemplary embodiment, air flows into the gap G through the first opening 250 (refer to FIG. 8). The air flowing in through the first opening 250 is restrained from flowing to the second opening 300 by an air stream flowing from the second opening 300 to the constriction portion 639. The air flowing in through the second opening 300 generally flows to the upstream-side suction port 621a along the upper surface 633 of the division portion 630.

As described above, the suction port 621 (refer to FIG. 11) is divided by the division portion 630 into the upstream-side suction port 621a and the downstream-side suction port 621b and the upstream-side suction port 621a has a larger opening than an opening of the downstream-side suction port 621b. Therefore, the flow rate of air sucked into the upstream-side suction port 621a is higher than the flow rate of air sucked into the downstream-side suction port 621b. In the present exemplary embodiment, as described above, air flowing from the upstream side to the downstream side in the main stream direction of the first flow path 510 is sucked into the upstream-side suction port 621a due to the upstream-side surface 631 of the division portion 630. Accordingly, the amount of a developer sucked into the downstream-side suction port 621b having a smaller opening than the opening of the upstream-side suction port 621a is suppressed, and the downstream-side suction port 621b clogged with the developer is suppressed.

The opening of the downstream-side suction port 621b is narrower than the opening of the upstream-side suction port 621a, and a speed at which air flows at the downstream-side suction port 621b is high. Therefore, the speed of air flowing from the gap G to the constriction portion 639 is high. In a case where the speed of air flowing through the constriction portion 639 is high, the speed of air flowing into the suction path 620 through the downstream-side suction port 621b is high.

For example, in a case where the division portion 630 is not provided, the speed of air passing through the suction port 621 (refer to FIG. 11) is low, and thus the air passing through the suction port 621 is likely to be stagnant. In a case where air passing through the suction port 621 is made stagnant, a developer is likely to accumulate near the suction port 621. For example, in a case where the developer accumulates on an end portion of the exterior cover 700 at the suction port 621, the developer after accumulation may drop down to an image region side, which may result in image defects. In the present exemplary embodiment, a wind speed in the suction port 621 is increased due to the constriction portion 639, and thus the developer after accumulation is restrained from dropping down to the image region side.

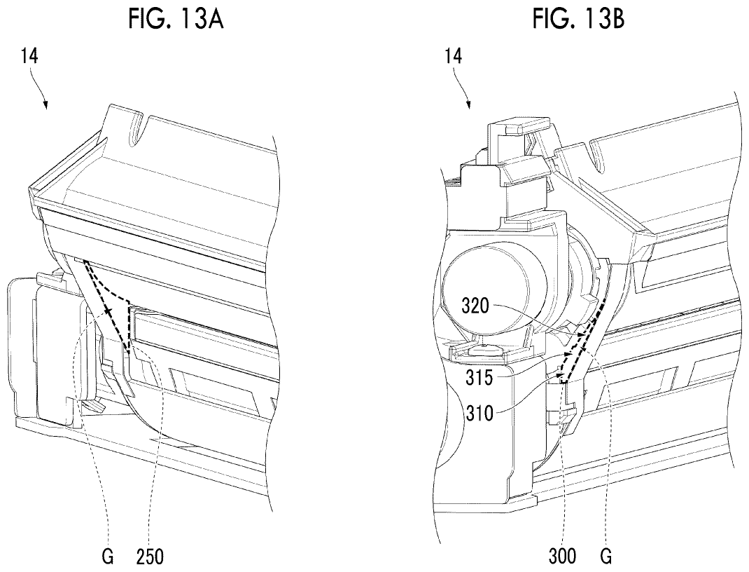

FIGS. 13A and 13B are views for comparison between the size of the first opening 250 and the size of the second opening 300. FIG. 13A is a view showing the first opening 250, and FIG. 13B is a view showing the second opening 300.

In the present exemplary embodiment, the sizes of the first opening 250 and the second opening 300 are different from each other.

In the present exemplary embodiment, the area of the second opening 300 is smaller than the area of the first opening 250.

Accordingly, a developer in the gap G is restrained from moving to the outside of the gap G through the second opening 300.

In the present exemplary embodiment, generally, air enters the gap G from the first opening 250 side.

In this case, a portion of the air entering the gap G from the first opening 250 side may move to the outside of the gap G through the second opening 300. In this case, a developer in the gap G is likely to move to the outside of the gap G through the second opening 300.

However, in the present exemplary embodiment, as described above, the area of the second opening 300 is smaller than the area of the first opening 250. In this case, a developer in the gap G is less likely to move to the outside of the gap G through the second opening 300 in comparison with a case where the area of the second opening 300 is larger than the area of the first opening 250.

### Supplementary Notes

(((1)))

A developing device that is composed of a plurality of constituent members and that causes a developer to adhere to an image holding body holding an image, the developing device comprising:
a facing member that is provided to be rotatable and that is disposed at a position facing the image holding body;
an opening that is disposed in a state of facing an image holding body side and that is for supply of the developer to the image holding body;
a blocking member that partially blocks the opening and that is disposed in a state where a gap is provided between the blocking member and the facing member that is disposed on a side opposite to a side on which the image holding body is installed with the blocking member interposed therebetween;
a flow path that extends in an axial direction of the facing member provided to be rotatable, through which air flows in the axial direction, and that reaches the gap at an end portion on a downstream side of a flow of the air in the axial direction;
a suction port that is provided at the end portion of the flow path on the downstream side in the axial direction and into which the air in the flow path is sucked in a direction intersecting the axial direction and air in the gap is sucked; and
a division portion that partially blocks the suction port and that divides the suction port into an upstream side and a downstream side in the axial direction.
(((2)))

The developing device according to (((1))),
wherein the division portion is disposed such that the upstream side of the suction port is wider than the downstream side of the suction port.
(((3)))

The developing device according to (((2))),
wherein the division portion extends from the suction port toward the gap.
(((4)))

The developing device according to any one of (((1))) to (((3))),
wherein the division portion includes an inclined surface of which a downstream side in the axial direction becomes higher as the inclined surface extends toward the gap, and
the developer on the inclined surface falls to an upstream side.
(((5)))

The developing device according to any one of (((2))) to (((4))),
wherein the division portion causes the air flowing in the axial direction in the flow path to be sucked from the upstream side and causes the air in the gap to be sucked from the downstream side.
(((6)))

The developing device according to any one of (((1))) to (((5))),
wherein one end-portion-side opening, which is an opening that allows air to flow into the gap, is provided between one end portion of the blocking member in the axial direction and the facing member, and
the other end-portion-side opening, which is an opening that allows the air to flow into the gap, is provided between the other end portion of the blocking member in the axial direction and the facing member.
(((7)))

The developing device according to (((6))),
wherein a size of the one end-portion-side opening and a size of the other end-portion-side opening are different from each other.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A developing device that is composed of a plurality of constituent members and that causes a developer to adhere to an image holding body holding an image, the developing device comprising:
a facing member that is provided to be rotatable and that is disposed at a position facing the image holding body;
an opening that is disposed in a state of facing an image holding body side and that is for supply of the developer to the image holding body;
a blocking member that partially blocks the opening and that is disposed in a state where a gap is provided between the blocking member and the facing member that is disposed on a side opposite to a side on which the image holding body is installed with the blocking member interposed therebetween;
a flow path that extends in an axial direction of the facing member provided to be rotatable, through which air flows in the axial direction, and that reaches the gap at an end portion on a downstream side of a flow of the air in the axial direction;
a suction port that is provided at the end portion of the flow path on the downstream side in the axial direction and into which the air in the flow path is sucked in a direction intersecting the axial direction and air in the gap is sucked; and
a division portion that partially blocks the suction port and that divides the suction port into an upstream side and a downstream side in the axial direction.

2. The developing device according to claim 1,
wherein the division portion is disposed such that the upstream side of the suction port is wider than the downstream side of the suction port.

3. The developing device according to claim 2,
wherein the division portion extends from the suction port toward the gap.

4. The developing device according to claim 3,
wherein the division portion includes an inclined surface of which a downstream side in the axial direction becomes higher as the inclined surface extends toward the gap, and
the developer on the inclined surface falls to an upstream side.

5. The developing device according to claim 2,
wherein the division portion causes the air flowing in the axial direction in the flow path to be sucked from the upstream side and causes the air in the gap to be sucked from the downstream side.

6. The developing device according to claim 1,
wherein one end-portion-side opening, which is an opening that allows air to flow into the gap, is provided between one end portion of the blocking member in the axial direction and the facing member, and
the other end-portion-side opening, which is an opening that allows the air to flow into the gap, is provided between the other end portion of the blocking member in the axial direction and the facing member.

7. The developing device according to claim 6,
wherein a size of the one end-portion-side opening and a size of the other end-portion-side opening are different from each other.
